(19) United States
(12) Patent Application Publication
(10) Pub. No.: US 2017/0340996 A1
(43) Pub. Date: Nov. 30, 2017

(54) Filter System and Vehicle State Monitoring Method

(71) Applicant: Qualc, Inc., Gyeonggi-do (KR)

(72) Inventors: Deok Su Jo, Gyeonggi-do (KR); Seo-Young Lee, Gyeonggi-do (KR)

(21) Appl. No.: 15/536,814

(22) PCT Filed: Feb. 15, 2016
(86) PCT No.: PCT/KR2016/001490

§ 371 Date: Jun. 16, 2017

(30) Foreign Application Priority Data
Feb. 13, 2015 (KR) 10-2015-0022376

(51) Int. Cl. B01D 35/143; G07C 5/00; F02B 77/04

(52) U.S. Cl. CPC B01D 35/143; F02B 77/04; G07C 5/008

(57) ABSTRACT

The present disclosure relates to a filter system and a method for monitoring a vehicle condition using the same. The filter system according to an embodiment of the present disclosure includes a sensing apparatus installed at an exterior surface of a housing of a filter having a bypass valve, and configured to sense the condition of the filter, wherein the sensing apparatus is configured to include a hole sensor for sensing magnetic force caused by a location of a bypass valve lid, and a communication unit for transmitting measurement data of the hole sensor to outside.

### FIELD

The present invention relates to a filter system and a vehicle state monitoring method, and more particularly, to a filter system capable of sensing the condition of a filter and a vehicle state monitoring method using the filter system.

### BACKGROUND

An oil filter of an engine plays a role of minimizing contamination of engine oil by foreign matter being introduced from outside, impurities such as dust and metal scraps generated in an internal-combustion engine, or combustion gas, and of removing even fine particles, thereby protecting the engine and always supplying clean engine oil to the engine.

Meanwhile, when foreign matter of an oil filter builds up in the process of being removed by the oil filter, and thus covers an entirety of a filter net of a filter box, the engine oil cannot be filtered through the filter net, and the pressure difference between the inside and outside of the filter box increases. Here, when the pressure difference increases to or above a certain magnitude, a bypass valve opens, and thus the engine oil containing the foreign matter will be supplied to the engine through a bypass hole, causing engine wear and efficiency decline.

In order to prevent these problems, a method for replacing the oil filter according to the mileage of a vehicle, and a method for installing an oil pressure sensor and the like inside the oil filter to predict the time to replace the oil filter according to signals from the oil pressure sensor, are being used. However, since it is impossible to directly know the opening of the bypass, these methods are inefficient or require an electric device to be installed inside the oil filter, and thus there are problems of lack of economic feasibility and safety.

### SUMMARY

Therefore, a purpose of the present disclosure is to provide a filter system capable of sensing a location of a bypass valve lid using a hole sensor installed outside a filter housing.

Another purpose of the present disclosure is to provide a filter system capable of determining a replacement period of the filter by sensing the location of the bypass valve lid.

Yet another purpose of the present disclosure is to provide a filter system capable of monitoring a condition of an apparatus where the filter is installed by sensing the location of the bypass valve lid.

Yet another purpose of the present disclosure is to provide a method capable of monitoring a condition of a vehicle where the filter system is installed, road condition, driver's driving behavior, and the replacement period of the filter according thereto, etc.

The aforementioned and other purposes of the present disclosure may all be achieved by a filter system and a vehicle state monitoring method according to the present disclosure.

A filter system according to an embodiment of the present disclosure is provided, the filter system including a sensing apparatus installed at an exterior surface of a housing of a filter having a bypass valve, the sensing apparatus configured to sense a condition of the filter and including a hole sensor for sensing a magnetic force caused by a location of a bypass valve lid, and a communication unit for transmitting measurement data of the hole sensor to outside.

The filter system according to an embodiment of the present disclosure may further include a magnet for forming a magnetic field between the bypass valve lid and the hole sensor.

The sensing apparatus may further include an auxiliary sensor for sensing temperature, tilt, and acceleration, and the communication unit may further transmit measurement data of the auxiliary sensor to outside.

The communication unit may include a short-distance communication module and a medium-to-long distance communication module, and when a user terminal and the short-distance communication module are connected to each other, the communication unit may transmit the measurement data to the user terminal through the short-distance communication module, and when the user terminal and the short-distance communication module are not connected to each other, the communication unit may transmit the measurement data to the user terminal through the medium-to-long distance communication module.

The sensing apparatus may further include a control unit, and the control unit may determine the condition of the filter or of the apparatus on which the filter is installed using one or more of the magnet force measurement data of the hole sensor, the measurement data of the auxiliary sensor, and whether the short-distance communication module and the user terminal are connected to each other, and the communication unit may transmit a determined result of the control unit to outside.

The filter system according to an embodiment of the present disclosure may further include the filter, and the filter may include a probe tip protruding from the bypass valve lid towards the exterior surface, and the sensing apparatus may sense a change in the magnetic force caused by the location of the probe tip.

The bypass valve lid may be attached to the bypass valve by a nonlinear spring.

The bypass valve may be installed so as to be relatively moveable with respect to the sensing apparatus during vibration from outside.

The bypass valve may be connected to the housing of the filter by a support spring.

A vehicle state monitoring method according to an embodiment of the present disclosure is provided, the method including receiving magnetic force measurement data caused by a location of a bypass valve lid; receiving temperature, tilt, and acceleration measurement data from an auxiliary sensor installed in the filter system; receiving information of whether a short-distance communication module installed in the filter system and a user terminal are connected to each other; determining that the vehicle is in a filter replacement period if the magnetic force measurement data is smaller than a first threshold value indicating the filter replacement period; and determining that the vehicle is in a driving condition if the short-distance communication module and the user terminal are connected to each other, and the magnetic force measurement data changes within a driving vibration range indicating driving vibration of the vehicle.

The driving vibration may be vibration caused by an engine operating, and the determining that the vehicle is in a driving condition may determine the driving condition of the vehicle further considering whether the temperature measurement data value rises.

The method may further include determining that the vehicle is in a robbed condition if the short-distance communication module and the user terminal are not connected to each other, and the magnetic force measurement data changes within the driving vibration range.

The method may further include determining that the vehicle is in a manual movement condition if the short-distance communication module and the user terminal are not connected to each other, the magnetic force measurement data does not change within the driving vibration range, and the tilt or the acceleration measurement data changes.

The method may further include notifying the condition of the vehicle to the user terminal through a medium-to-long distance communication module installed in the filter system.

The method may further include determining that a sliding of the vehicle occurred if the magnetic force measurement data value rises and the acceleration measurement data rises.

The method may further include determining the condition of a road surface considering the acceleration measurement data in a direction vertical to the vehicle and a range of change caused by engine vibration.

The method may further include determining that a vehicle accident occurred if the tilt measurement data value is or above a predetermined threshold value, and notifying the accident condition to outside.

The filter system according to an embodiment of the present disclosure may sense the location of the bypass valve lid using the hole sensor installed outside the filter housing, thereby providing the effects of sensing the location of the bypass valve lid economically and stably, and easily notifying the replacement period of the filter using the same.

Further, the filter system according to an embodiment of the present disclosure has the effect of monitoring the condition of the apparatus where the filter is installed based on the location of the bypass valve lid, for example, if the filter is installed in a vehicle, the filter system has the effect of understanding the vehicle condition, road condition, driver's driving behavior, and their effects on the replacement period of the filter, etc.

### BRIEF DESCRIPTION OF THE DRAWINGS

FIG. 1 is a cross-sectional view of a filter system according to an embodiment of the present disclosure;

FIG. 2 are enlarged views of portion A of FIG. 1;

FIG. 3 are views illustrating a configuration of a probe tip;

FIG. 4 are views illustrating operations of a bypass valve using a linear spring;

FIG. 5 and FIG. 6 are views illustrating operations of a bypass valve using a nonlinear spring;

FIG. 7 is a graph showing changes in the distance between the probe tip and a sensor and changes in the magnetic force, as a function of pressure difference;

FIG. 8 are views showing movements of a filter net connected to a housing by a support spring;

FIG. 9 is a cross-sectional view of a filter system according to another embodiment of the present disclosure;

FIG. 10 is a configuration view of the overall system for monitoring a vehicle condition;

FIG. 11 is a flowchart showing a method for monitoring a vehicle condition according to an embodiment of the present disclosure;

FIG. 12 is a flowchart showing a method for transmitting data in a filter system according to an embodiment of the present disclosure;

FIG. 13 is an exemplary graph showing vibration of magnetic force measurement data when starting a engine;

FIG. 14 is an exemplary graph showing vibration of magnetic force measurement data when a vehicle is in a driving condition;

FIG. 15 is a flowchart for determining a vehicle condition in the method for monitoring a vehicle condition according to an embodiment of the present disclosure; and

FIG. 16 is a flowchart for determining road condition and vehicle accident in a method for monitoring a vehicle condition according to an embodiment of the present disclosure.

### DETAILED DESCRIPTION

Hereinafter, a filter system and a method for monitoring a vehicle condition according to the present disclosure will be explained in detail with reference to the drawings attached.

The explanation hereinafter is only for parts that are necessary to understand the filter system and the method for monitoring a vehicle condition according to an embodiment of the present disclosure, and explanation on other parts may be omitted so as not to obscure the gist of the present disclosure.

Furthermore, all the words and terms used in the present specification and claims should not be construed conventionally or limitedly as having meanings defined in dictionaries, but should be interpreted as having meanings and concepts that are suitable to the technical concept of the present disclosure so that they can express the present disclosure most appropriately.

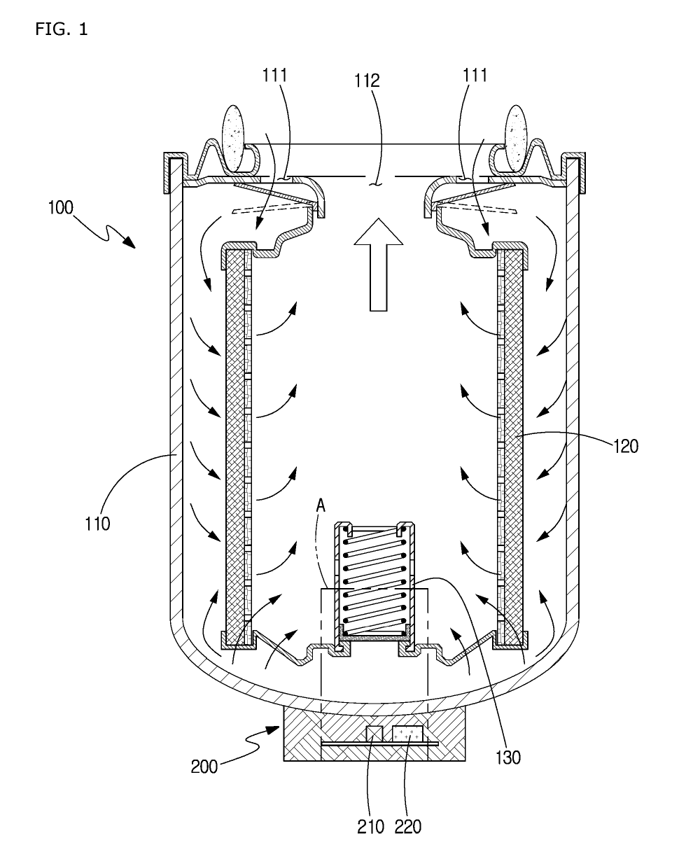

FIG. 1 illustrates a filter system according to an embodiment of the present disclosure.

As illustrated in FIG. 1, the filter system according to an embodiment of the present disclosure is configured to include a sensing apparatus 200 coupled to a filter 100.

The sensing apparatus 200 is provided with a hole sensor 210 configured to sense magnetic force, and a communication unit 220 configured to transmit the data sensed in the hole sensor to outside.

The sensing apparatus 200 may monitor a condition of a bypass valve as the hole sensor senses the magnetic force (magnetic flux density) that changes according to the location of a bypass valve lid 131.

Since the sensing apparatus uses the method for sensing magnetic force, installing the sensing apparatus at an exterior surface of a housing 110, and not inside the filter, is enough to monitor the condition of the bypass valve. The sensing apparatus may be installed at the exterior surface of the housing in a form where it is integrated with the housing or separable from the housing.

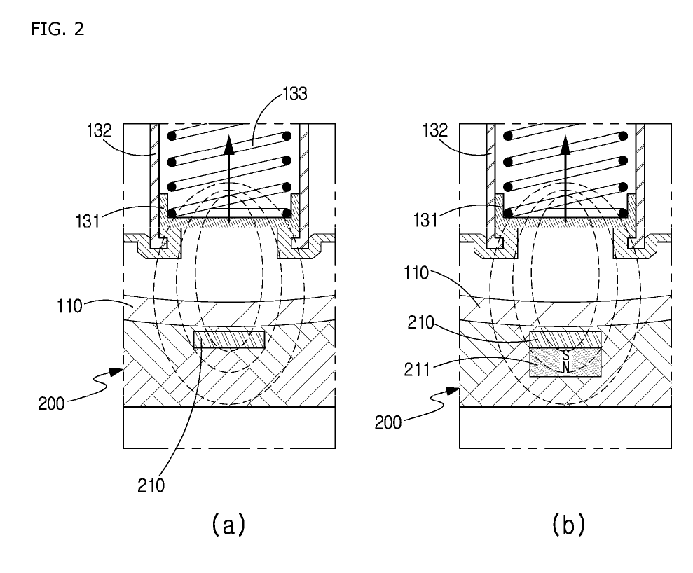

It is preferable that the hole sensor 210 is located on an extension of the movement path of the bypass valve lid as illustrated in FIG. 2a so that the sensing apparatus may easily sense changes in the magnetic force according to movement of the location of the bypass valve lid.

In the case where the bypass valve lid 131 is a magnet, the location of the lid may be identified as the hole sensor 210 measures the intensity of the magnetic field formed by the lid.

Further, as illustrated in FIG. 2b, it is possible to provide a magnet 211 inside the sensing apparatus 200 to form a magnetic field and measure, by the hole sensor 210, changes in the magnetic force caused by the movement of the lid, thereby identifying the location of the lid. Here, the lid may be made of any material that may affect the magnetic field being formed by the magnet.

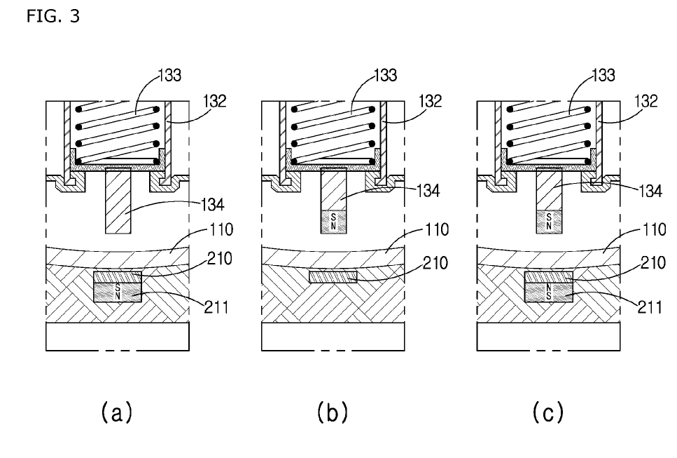

As illustrated in FIG. 3, the filter system according to an embodiment of the present disclosure may further include a probe tip 134 protruding from the lid towards the exterior surface of the housing to which the sensing apparatus 200 is attached, so that the magnetic force can be measured more easily in the hole sensor 210.

That is, this is providing the probe tip for the case where the magnetic force by the bypass valve lid cannot be measured or the magnetic force is weak, so that the hole sensor 210 can measure the magnetic force caused by changes in the location of the probe tip, through which the location of the bypass valve lid may be identified.

Here, the probe tip may be a magnet, partially magnet, or made of a material that can change the magnetic force of the magnetic field being formed by the magnet 211 inside the sensing apparatus.

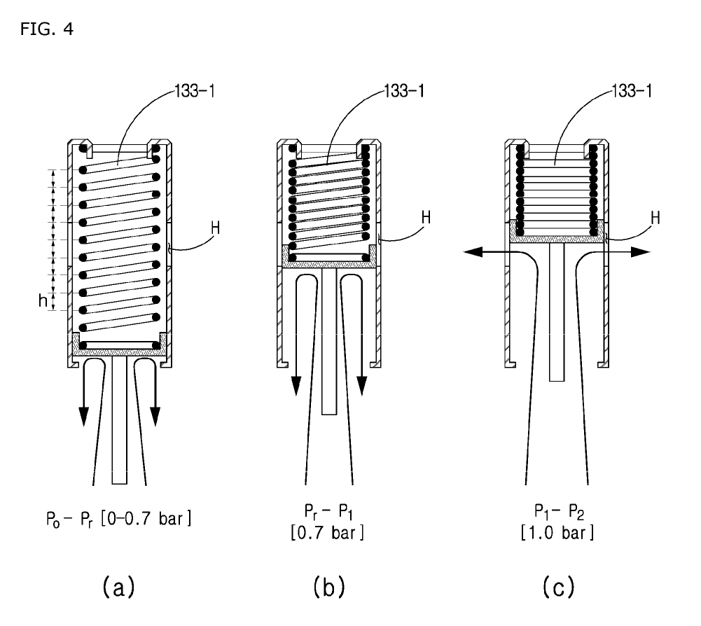

If the filter is used continuously, foreign matter may build up on the surface of the filter net, causing pressure difference between the inside and outside of the filter net. If this pressure difference increases, as illustrated in FIGS. 4 to 6, the bypass valve lid 131 will be moved in a direction where the bypass valve lid 131 compresses a bypass spring 133, and when a hole H formed in the bypass valve opens, unrefined oil will be discharged through the opened hole H.

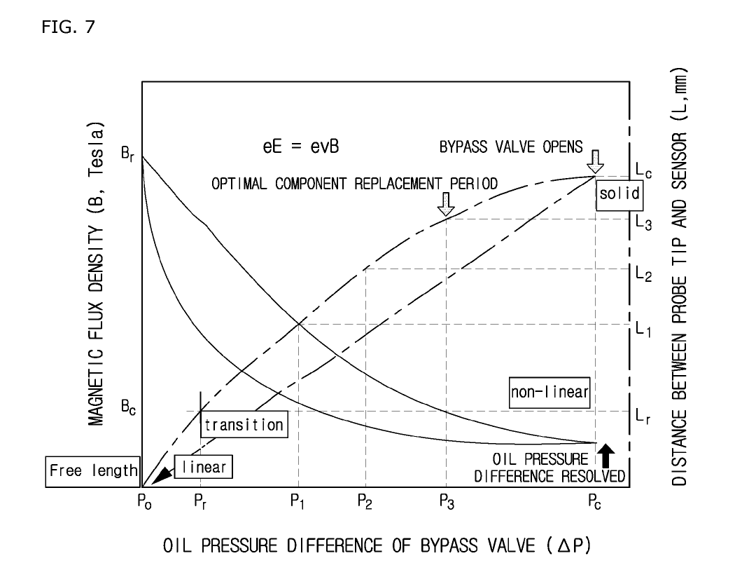

As illustrated in FIG. 7, when the pressure difference increases, as the bypass valve lid moves, the distance between the hole sensor 210 and the bypass valve lid (or probe tip) increases, and thus the magnitude of the magnetic force being sensed by the hole sensor decreases. The filter system according to an embodiment of the present disclosure senses such changes in the magnetic force, and notifies it to outside through the communication unit 220, thereby allowing a user to know whether the filter is in a good condition, or the filter is in a phase where it should be replaced, or whether the bypass valve is open, etc.

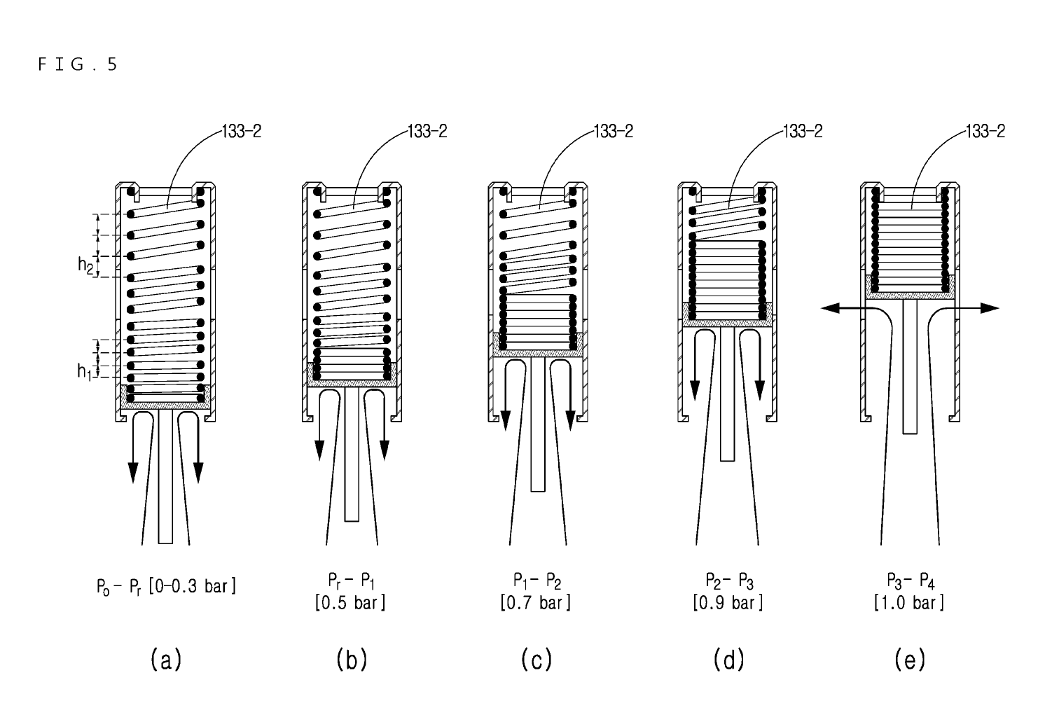

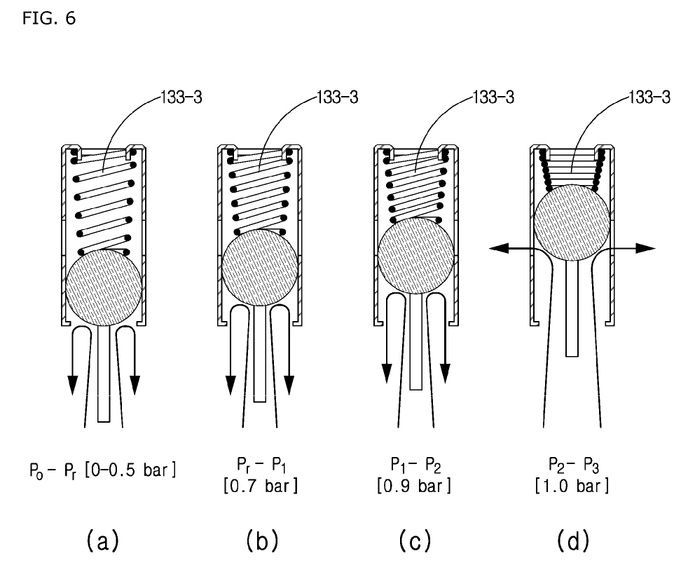

For the bypass spring 133 of the filter system according to an embodiment of the present disclosure, a linear spring having a uniform spring distance h as that illustrated in FIG. 4, or a non-linear spring as that illustrated in FIG. 5 and FIG. 6 may be used.

The non-linear spring is a spring, as illustrated in FIGS. 5 and 6, with spring distances h or diameters of spring circle that gradually change and thus starts to be compressed by a smaller pressure than the linear spring illustrated in FIG. 4, and reacts more sensitively to the changes in pressure.

When using such a non-linear spring, the location of the bypass valve lid 131 changes more sensitively to the changes in pressure, and based on the location of the bypass valve lid that changes sensitively, the filter system according to an embodiment of the present disclosure may determine more various conditions of the filter and/or of the apparatus on which the filter is mounted.

Further, in the filter system according to an embodiment of the present disclosure, the filter net 120 that includes the bypass valve 130 may be installed such that it is moveable in relation to the filter housing 110.

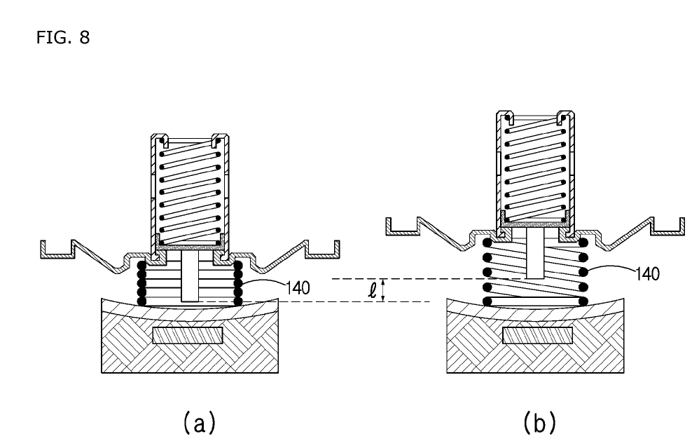

That is, as illustrated in FIG. 8, the filter net 120 may be connected to the housing 110 by a support spring 140. In this case, even if the housing and the sensing apparatus 200 move due to an impact, vibration and the like, the filter 120, that is not integrally coupled to the housing, remains in its original location due to inertia.

When seen from the perspective of the sensing apparatus 200, such a phenomenon will be observed as if the lid of the bypass valve was moved by an impact, vibration and the like, and thus the filter system according to an embodiment of the present disclosure becomes able to sense the impact, vibration and the like generated in the apparatus where the filter system is installed. That is, in the case where the filter system according to an embodiment of the present disclosure is installed in an oil filter of a vehicle, it is possible to sense the engine vibration caused by starting and driving the vehicle.

Here, a movement range I of the support spring may be set to be within the range of the vibration to be sensed, and it is preferable that the movement range is within a relatively smaller movement range than that of the bypass spring.

Meanwhile, the magnetic force data sensed by the hole sensor may be transmitted outside through the communication unit 220, thereby providing the user with information of the condition of the filter and/or of the apparatus on which the filter is mounted.

Here, the communication unit 220 may be configured to include a short distance communication module and/or a medium-to-long distance communication module.

Therefore, in the case where a user terminal 300 is located closely to the filter system, the filter system according to an embodiment of the present disclosure may transmit the sensed magnetic force data to the user terminal through the short distance communication module such as bluetooth.

Further, in the case where the user terminal 300 is not within the communication range of the short distance communication module, the filter system according to an embodiment of the present disclosure may transmit the sensed magnetic force data to the user terminal through the medium-to-long distance communication module such as a transceiver.

The filter system according to an embodiment of the present disclosure may determine the condition of the apparatus on which the filter is mounted using information of whether the filter system is connected with the user terminal by the short distance communication module, and this will be explained hereinafter.

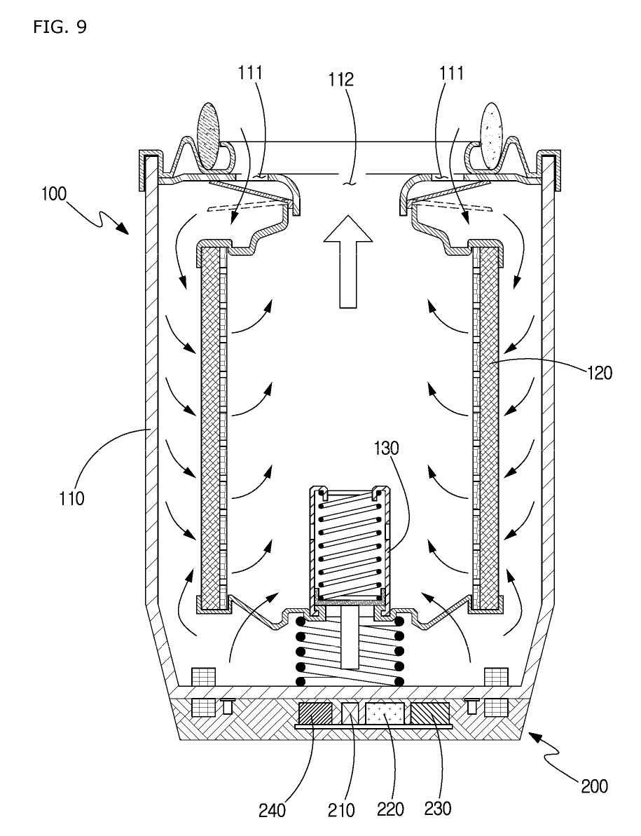

The filter system according to another embodiment of the present disclosure is illustrated in FIG. 9. The filter system according to the another embodiment of the present disclosure illustrated in FIG. 9 further includes an auxiliary sensor 230 and a control unit 240 inside the sensing apparatus 200 unlike the filter system illustrated in FIG. 1.

The auxiliary sensor 230 is a sensor for further sensing various information besides the location of the bypass valve lid. The auxiliary sensor 230 may be, for example, a temperature sensor, a tilt sensor, an acceleration sensor, a direction sensor, and an impact sensor, etc.

The filter system according to an embodiment of the present disclosure may be provided with one or more auxiliary sensors, and may be an integrated sensor, such as a 9-axis sensor, configured to sense various information (tilt, direction and acceleration).

The filter system according to the another embodiment of the present disclosure may monitor the condition of the filter and/or of the apparatus on which the filter is mounted more precisely or monitor more various conditions thereof than the filter system illustrated in FIG. 1, using the data sensed by the auxiliary sensor.

For example, in the case where there is a temperature change, even if the location of the bypass valve lid does not change, a magnetic force data value measured by the hole sensor 210 may change. Here, using the temperature information sensed by the temperature sensor, it is possible to correct the magnetic force data value measured by the hole sensor and determine the location of the bypass valve lid more accurately.

Further, using the tilt, acceleration, direction, impact data and the like sensed by the auxiliary sensor, it is possible to determine conditions such as whether the apparatus on which the filter is mounted is tilted, moved, or received impact from outside.

The control unit 240 may control the filter system according to an embodiment of the present disclosure to sense various information and to transmit the sensed information to outside. Further, the control unit may also control the filter system to analyze the condition of the filter and/or of the apparatus on which the filter is mounted using the measurement data sensed by the hole sensor and the auxiliary sensor, and whether the short-distance communication module and the user terminal are connected to each other and the like, and to transmit the analyzed result to outside.

Although FIG. 9 illustrates an embodiment that further includes the auxiliary sensor and control unit in the filter system illustrated in FIG. 1, this may be changed to further include only the auxiliary sensor or only the control unit.

As mentioned so far, the filter system according to an embodiment of the present disclosure may be provided such that the sensing apparatus 200 is attachable to the exterior surface of the housing of the filter, or that the filter 100 and the sensing apparatus 200 are coupled to each other, and may sense the location of the bypass valve lid installed in the filter based the magnetic force and sense various additional information, thereby allowing the user to monitor various conditions of the filter and/or of the apparatus on which the filter is mounted.

Hereinafter, explanation will be made in more detail on how to monitor the conditions of the filter and/or of the apparatus on which the filter is mounted using the filter system according to an embodiment of the present disclosure.

Further, hereinafter, the explanation will be made based on an example of a method for monitoring a condition of a vehicle on which the filter system according to an embodiment of the present disclosure is mounted so that one can easily understand the filter system and the condition monitoring method. However, it should be understood that the filter system according to an embodiment of the present disclosure and the apparatus on which the filter system is mounted are not limited to the oil filter and to monitoring the vehicle condition.

Embodiments hereinafter will be explained with reference to the flowcharts presented in the drawings, and although the method is illustrated and explained by means of a series of blocks in the drawings for a brief explanation, the present disclosure is not limited to the order of those blocks, and some of the blocks may be realized with the other blocks in a different order from that illustrated and described in the present specification, or at the same time, and various orders of branches, flow paths and blocks, that achieve the same or similar results, may be realized. Further, not all the blocks illustrated may be required to realize the method being described in the present specification.

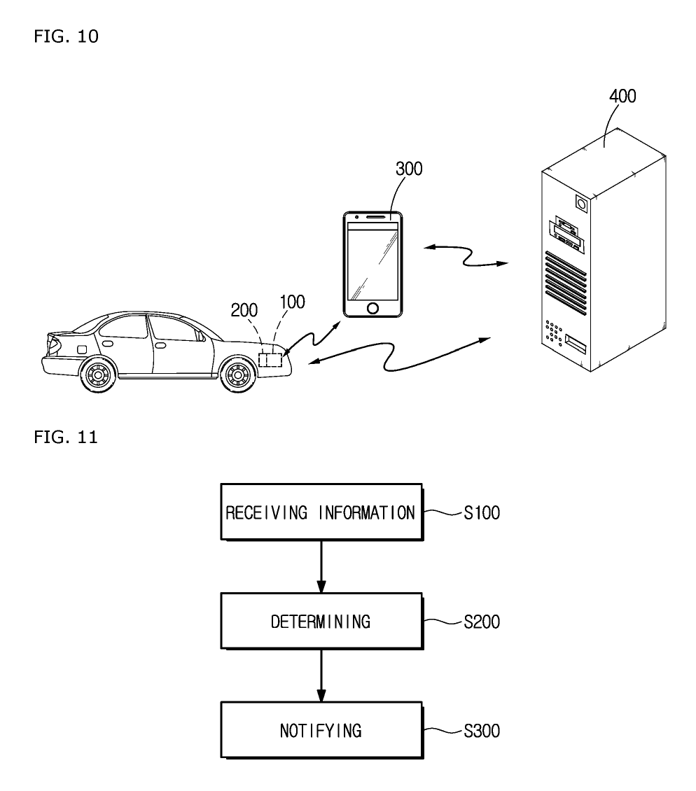

FIG. 10 illustrates a vehicle on which the filter system according to an embodiment of the present disclosure is mounted, and the user terminal 300 and server system 400 associated with the filter system.

As illustrated in FIG. 10, the filter system according to an embodiment of the present disclosure is an oil filter system of the vehicle, and monitors the condition of an oil filter and/or the vehicle, and provides information to the user terminal 300 and/or the server system 400.

The user terminal 300 provides the information received from the filter system to the user, so that the user can know the condition of the filter and/or of the vehicle, and for this purpose, an application to be associated with the filter system may be installed in the user terminal 300.

The server system 400 may receive the information of the filter and/or of the vehicle from the filter system and/or the user terminal, and may obtain statistical information of the vehicle condition, condition of the road on which the vehicle is being driven, the effect the vehicle condition has on the vehicle components including the filter and the like, using the received information.

The method for monitoring a vehicle condition according to an embodiment of the present disclosure may be configured to include a step of receiving information (S100), a step of determining (S200) and a step of notifying (S300), as illustrated in FIG. 11.

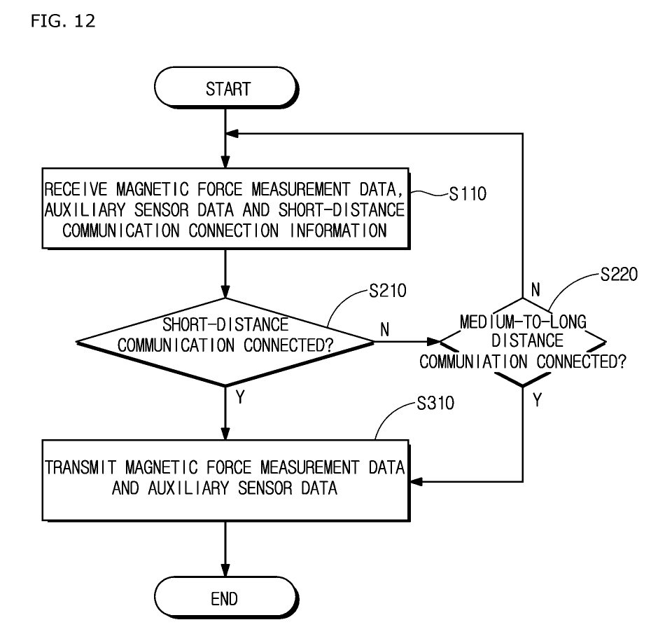

Such a method for monitoring a vehicle condition according to an embodiment of the present disclosure may be performed by the filter system, which will be explained in more detail hereinafter with reference to FIG. 12.

The control unit 240 may receive magnetic force measurement data, auxiliary sensor data and communication connection information from the hole sensor 210, the communication unit 220 and the auxiliary sensor 230 (S110).

The control unit determines whether the communication unit is connected with the user terminal via short-distance communication using the received communication connection information (S210), and if so (that is, connected via short-distance communication), controls such that the magnetic force measurement data and the auxiliary sensor data are transmitted to the user terminal (S310).

Further, if not connected via short-distance communication, the control unit determines whether it is connected via medium-to-long distance communication (S220), and if so (that is, connected via medium-to-long distance communication), controls such that the magnetic force measurement data and the auxiliary sensor data are transmitted to the user terminal (S310).

On the other hand, if the communication unit is not connected with the user terminal, the control unit may maintain the filter system in a slip condition, and control such that, if an impact, vibration and the like occurs in the vehicle, the communication unit is connected to the user terminal and the sensed measurement data is transmitted to the user terminal.

As such, the filter system may transmit the measurement data sensed in the hole sensor and/or the auxiliary sensor to the user terminal as it is, and the application of the user terminal may analyze the received measurement data to determine the condition of the filter and/or of the vehicle, and provide the determined condition to the user and/or the server system.

However, the control unit of the filter system may analyze the measurement data sensed in the hole sensor and/or the auxiliary sensor to determine the condition of the filter and/or of the vehicle, and provide the determined information to the user terminal and/or the server system.

Therefore, the method for monitoring a vehicle condition according to an embodiment of the present disclosure may be performed by the control unit of the filter system or by the user terminal, and may specifically determine the vehicle condition using the received information and notify the determined vehicle condition.

First of all, it is possible to determine the filter condition of the vehicle using the magnetic force measurement data and the auxiliary data received.

More specifically, if the received magnetic force measurement data is smaller than a first threshold value that indicates the replacement period of the filter, it is possible to determine that the filter is in a condition where it needs to be replaced, and notify the same, whereas if the received magnetic force measurement data is greater than the first threshold value, it is possible to determine that the filter is in a good condition, and notify the same. In the graph illustrated in FIG. 7, the first threshold value is B_{C} which may be set by a person skilled in the art to an appropriate first threshold value depending on the filter.

Further, if the received magnetic force measurement data is smaller than a second threshold value that indicates that the bypass valve is open, it is possible to determine that the bypass valve is in an open condition, and notify the same. The second threshold value is a smaller value than the first threshold value, and the second threshold value may be set to an appropriate second threshold value by a person skilled in the art depending on the filter.

Here, depending on the temperature of the filter system, the magnetic force measurement data may be smaller than the first threshold value even when the filter is not in a condition where it needs to be replaced, or the magnetic force measurement data may be smaller than the second threshold value even when the bypass valve is not open. In such a case, it is possible to determine the condition of the filter more accurately by correcting the first threshold value and the second threshold value using the auxiliary sensor data of the temperature.

Further, it is possible to determine the driving condition of the vehicle using the magnetic force measurement data and the auxiliary sensor data received.

More specifically, when starting the vehicle, vibration occurs as the engine starts to operate, whereas, while the vehicle is in a driving condition, vibration occurs continuously due to the operation of the engine.

The filter housing 110 and the sensing apparatus 200 connected to the engine vibrate together with the engine, but as illustrated in FIG. 8, the filter net 120 and the bypass valve 130 connected by the support spring 140 do not vibrate together with the sensing apparatus 200 due to inertia, and the relative movement occurred accordingly is sensed by the hole sensor 210.

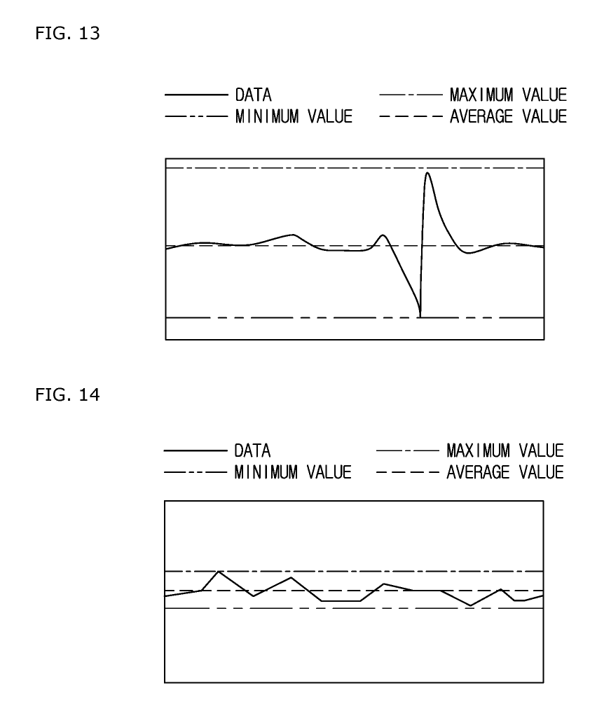

When the engine is being started, for example, the magnetic force measurement data vibrates as illustrated in FIG. 13, and thereafter vibrates as illustrated in FIG. 14.

Such vibration may be regarded a driving vibration range, and as can be seen from FIG. 7, it may be differentiated from the changes in the magnetic force measurement data caused by the movement of the bypass valve lid.

Therefore, if the received magnetic force measurement data vibrates within the driving vibration range, it is possible to determine that the vehicle is in a driving condition.

Further, when a vehicle is in a driving condition, as the engine oil heated in the engine is introduced into the filter, the temperature value measured in the auxiliary sensor increases. Therefore, it is possible to determine the driving condition of the vehicle by further considering whether the temperature measurement data rose higher than before the magnetic force measurement data value vibrated.

The aforementioned method for monitoring a vehicle condition according to an embodiment of the present disclosure may monitor the driving condition of the vehicle, and may thus further monitor the replacement periods of the vehicle components that need to be replaced depending on the mileage, condition of robbery of the vehicle and condition of manual movement and the like.

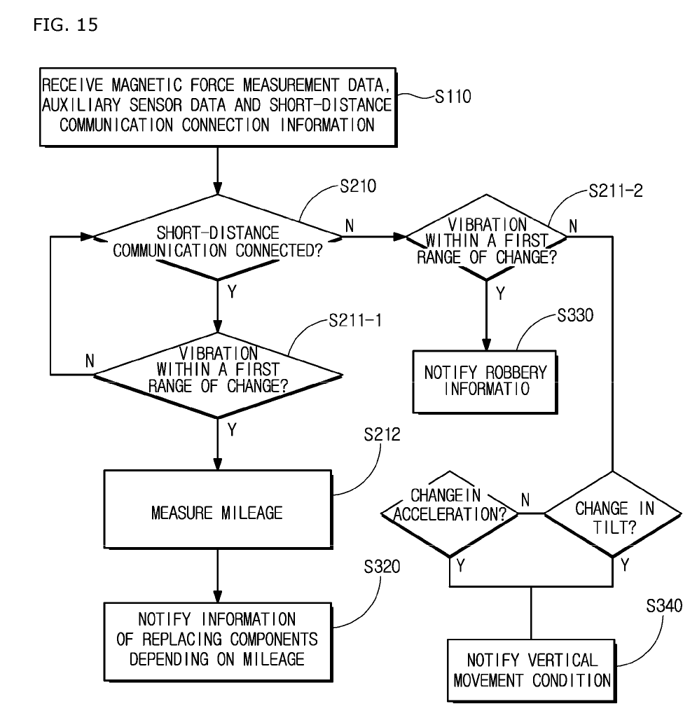

This will be explained in further detail hereinafter with reference to FIG. 15.

First of all, the magnetic force measurement data, auxiliary sensor data, and short-distance communication connection information are received (S110).

Thereafter, whether the filter system and the user terminal are connected to each other via short-distance communication is determined using the short-distance connection information of the received information (S210). Through this, it is possible to determine whether a user is in the vehicle.

Further, whether the magnetic force measurement data vibrates within the driving vibration range is determined (S211). Through this, it is possible to determine whether the vehicle is in a driving condition.

If the filter system and the user terminal are connected via short-distance communication and the magnetic force measurement data vibrates within the driving vibration range, it is possible to determine that the vehicle is in a normal driving condition. Accordingly, it is possible to measure the mileage (S212), and notify the replacement periods of the components that need to be replaced depending on the mileage (S320).

Further, if the filter system and the user terminal are connected to each other via short-distance communication and the magnetic force measurement data vibrates within the driving vibration range, it is possible to determine that the vehicle is in a normal driving condition. Accordingly, it is possible to measure the mileage (S212), and notify the replacement periods of the components that need to be replaced depending on the mileage (S320).

Further, if the filter system and the user terminal are not connected to each other via short-distance communication and the magnetic force measurement data vibrates within the driving vibration range, it is possible to determine that the vehicle is in a robbed condition. Accordingly, vehicle robbery information may be notified (S330).

Further, if it is determined that the magnetic force measurement data does not vibrate within the driving vibration range but the tilt of the vehicle changed or the acceleration changed in the auxiliary sensor data in a state where the filter system and the user terminal are not connected to each other via short-distance communication, it is possible to determine that the vehicle is in a manual movement condition, and notify the manual movement condition accordingly (S340). Here, the manual movement condition may be, for example, a towing condition or a slidable condition of the vehicle parked on a sloped land.

Further, the method for monitoring a vehicle condition according to an embodiment of the present disclosure may also monitor the condition of the road on which the vehicle is being driven, accident condition of the vehicle, etc.

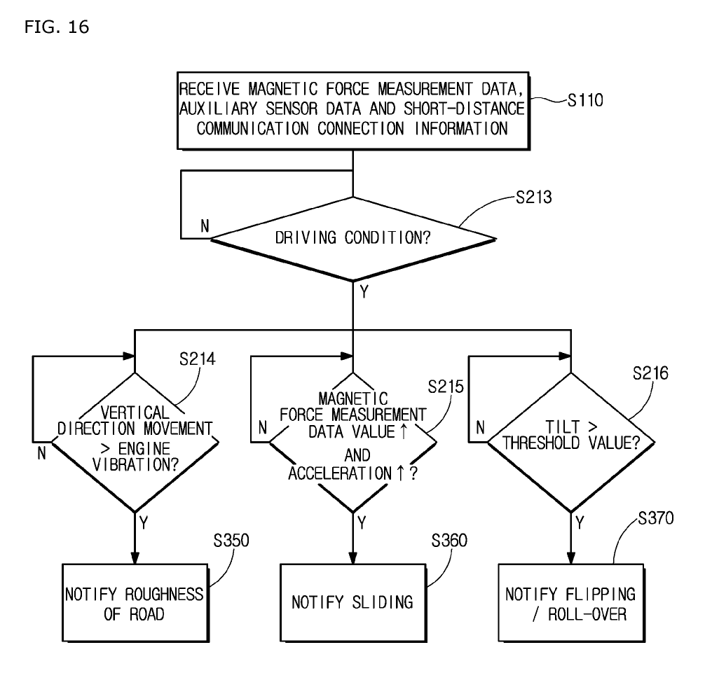

This will be explained in more detail hereinafter with reference to FIG. 16.

First of all, the magnetic force measurement data, auxiliary sensor data, and short-distance communication connection information are received (S110).

Thereafter, whether the vehicle is in a driving condition is determined using the received information (S213).

If it is determined that the vehicle is in a driving condition, it is possible to determine whether a vertical direction movement of the vehicle exceeds the engine vibration range (S214). That is, if the vehicle is in a driving condition and the condition of the road is not good, a vertical direction (vertical to the road surface) movement of the vehicle occurs, which may be sensed by the auxiliary sensor configured to measure vertical direction acceleration. However, when a vehicle is in a driving condition, vertical direction movements may occur due to engine vibration. Therefore, it is possible to determine whether the vertical direction movement sensed by the auxiliary sensor is greater than the vertical direction movement caused by the engine vibration, and notify the roughness of the road using the difference value of the magnitude of the vertical direction movement and the magnitude of the vertical direction movement caused by the engine vibration.

Such road roughness information may be notified to the server system 400, and the server system may secure statistical information that the road roughness has on the replacement period of the filter using the road roughness information and the filter replacement information received from each filter system.

Further, if it is determined that the vehicle is in a driving condition, it is possible to determine whether a sliding of the vehicle occurred using the magnetic force measurement data and the acceleration data measured by the auxiliary sensor (S215), and if so (that is, a sliding of the vehicle occurred), notify that information (S360).

More specifically, if a driver hits the brake while driving a vehicle, the amount of engine oil being introduced into the filter decreases, and the pressure being applied to the bypass valve lid decreases, thereby raising the magnetic force measurement data value. If a driver hits the brake while driving a vehicle, the acceleration of the vehicle should decrease, and thus if the acceleration of the vehicle rises to the contrary, it is possible to determine that a sliding of the vehicle occurred.

Such a sliding condition may be notified to the user and induce the user to drive safely by reducing the speed and the like. Further, the sliding condition may be notified to the server system, so that information on the road condition may also be provided to drivers of other vehicles.

Further, if it is determined that the vehicle is in a driving condition, it is possible to determine whether the vehicle flipped/rolled-over based on whether the tilt of the vehicle exceeds the threshold value (S216), and notify that an accident occurred (S370).

For example, if the vehicle is tilted by 90 degrees based on the proceeding direction, it may be determined that a flipping accident occurred, and if the vehicle is tilted by 180 degrees based on the proceeding direction, it is possible to determine that a roll-over accident occurred.

In a such case, it is possible to notify the accident condition to the server system, thereby allowing a rescue or accident handling caused by the vehicle accident to be performed quickly. Here, the server system may be an emergency accident receiving system such as a police system, and firefighting system, etc.

While a filter system and a method for monitoring a vehicle condition according to the present disclosure were described with reference to specific embodiments, it is to be understood that the present invention is not limited to these specific embodiments, but is intended to cover various modifications and equivalent arrangements without deviating from the spirit and range of the invention in the claims.

1.-9. (canceled)

10. A method for monitoring a condition of a vehicle where a filter system is installed, the method comprising:
receiving magnetic force measurement data caused by a location of a bypass valve lid;
receiving temperature, tilt, and acceleration measurement data from an auxiliary sensor installed in the filter system;
receiving information of whether a short-distance communication module installed in the filter system and a user terminal are connected to each other;
determining that the vehicle is in a filter replacement period if the magnetic force measurement data is smaller than a first threshold value indicating the filter replacement period; and
determining that the vehicle is in a driving condition if the short-distance communication module and the user terminal are connected to each other, and the magnetic force measurement data changes within a driving vibration range indicating driving vibration of the vehicle.

11. The method according to claim 10, wherein the driving vibration is vibration caused by an engine operating, and
the determining that the vehicle is in a driving condition determines the driving condition of the vehicle further considering whether the temperature measurement data value rises.

12. The method according to claim 10, further comprising determining that the vehicle is in a robbed condition if the short-distance communication module and the user terminal are not connected to each other, and the magnetic force measurement data changes within the driving vibration range.

13. The method according to claim 10, further comprising determining that the vehicle is in a manual movement condition if the short-distance communication module and the user terminal are not connected to each other, the magnetic force measurement data does not change within the driving vibration range, and the tilt or acceleration measurement data changes.

14. The method according to claim 12, further comprising notifying the vehicle condition to the user terminal through a medium-to-long distance communication module installed in the filter system.

15. The method according to claim 10, further comprising determining that a sliding of the vehicle occurred if the magnetic force measurement data value rises and the acceleration measurement data rises.

16. The method according to claim 10, further comprising determining the condition of a road surface considering the acceleration measurement data in a direction vertical to the vehicle and a range of change caused by engine vibration.

17. The method according to claim 10, further comprising determining that a vehicle accident occurred if the tilt measurement data value is or above a predetermined threshold value, and notifying the accident condition to outside.

18. The method according to claim 13, further comprising notifying the vehicle condition to the user terminal through a medium-to-long distance communication module installed in the filter system.
